(19) United States
(12) Patent Application Publication
(10) Pub. No.: US 2025/0343800 A1
(43) Pub. Date: Nov. 6, 2025

(54) METHOD AND SYSTEM FOR AUTHENTICATING A USER ON AN IDAAS SERVER TO ACCESS AN APPLICATION

(71) Applicant: BULL SAS, LES-CLAYES-SOUS-BOIS (FR)

(72) Inventor: Christophe GUIONNEAU, GRENOBLE (FR)

(73) Assignee: BULL SAS, LES-CLAYES-SOUS-BOIS (FR)

(21) Appl. No.: 19/054,739

(22) Filed: Feb. 14, 2025

(30) Foreign Application Priority Data
Feb. 23, 2024 (EP) 24305300.6

(51) Int. Cl. H04L 9/40; H04L 9/32

(52) U.S. Cl. CPC H04L 63/105; H04L 9/321

(57) ABSTRACT

The invention relates to a method (100) for authenticating a user to an identity-as-a-service server, IDAAS server, in order to access an application, said method (100) comprising the following steps:
authenticating (128) said user to said IDAAS server according to an authentication method,
in the event of successful authentication, determining (132) a trust score as a function of an authentication score previously associated with said authentication method and representative of a trust placed in said authentication method, and
generating (134) an authentication message comprising a proof of authentication and said trust score, intended for use by an authentication server controlling access to said application.
   It also relates to a computer program, IDAAS server, and authentication system implementing such a method.

This application claims priority to European Patent Application Number 24305300.6, filed 23 Feb. 2024, the specification of which is hereby incorporated herein by reference.

### BACKGROUND OF THE INVENTION

### Field of the Invention

At least one embodiment of the invention relates to a method for authenticating a user on an identity-as-a-service server, an IDAAS server, in order to access an application. At least one embodiment of the invention also relates to a server and a system implementing such a method.

The field of one or more embodiments of the invention is the field of authenticating a user with an IDAAS server, in particular with a view to accessing one or more local applications, or one or more applications in SaaS mode, also called web applications.

### Description of the Related Art

Applications and services increasingly use identity federation. In short, the user self-authenticates to an authentication server, also known as an identity provider, and obtains a proof of authentication. This proof of authentication is then used to access multiple applications, avoiding the need for individual authentication for each application.

Authentication consists in verifying the data provided by a user and authorizing that person to use an associated digital identity.

In a corporate network, it's the company that creates, assigns, and manages all digital identities. Proof of authentication can be obtained either within the corporate computer network, or via a server external to the corporate network, called IDAAS server (for “Identity As A Service”).

Also known are authentication services that perform social authentication, whether government-backed or not, such as FranceConnect®, SwissID®, Google, Facebook®, etc.: the user creates his/her own digital identity during a registration phase, when he/she is asked for specific information. These services provide identity federation through authentication APIs, enabling proof of authentication to be conveyed for use by external applications.

All these identity providers use different authentication mechanisms and manage digital identities in different ways, which makes a big difference in terms of trust/security. What's more, there is currently no solution for using different, and potentially all, identity providers to authenticate a user for access to an application.

One aim of at least one embodiment of the invention is to solve at least one of the above-mentioned shortcomings.

Another aim of at least one embodiment of the invention is to provide a solution for authenticating a user to an IDAAS server in order to access an application, which is more flexible in particular in terms of identity provider.

### BRIEF SUMMARY OF THE INVENTION

At least one embodiment of the invention makes it possible to achieve at least one of the aforementioned aims with a method for authenticating a user to an identity-as-a-service server, called an IDAAS server, in order to access an application, said method comprising the following steps:
authenticating said user to said IDAAS server according to an authentication method,
in the event of successful authentication, determining a trust score as a function of an authentication score previously associated with said authentication method and representative of a trust placed in said authentication method, and
generating an authentication message comprising a proof of authentication and said trust score, intended for use by an authentication server controlling access to said application.

Thus, in a conventional way, at least one embodiment of the invention proposes a method for authenticating a user by an IDAAS server in order to access an application. The proof of authentication is then used to access an application, for example by an authentication server managing access to said application.

In an innovative way, one or more embodiments of the invention proposes to perform authentication using one of several authentication methods. Thus, at least one embodiment of the invention makes it possible to implement different authentication methods within the IDAAS server, namely a local method managed by the IDAAS server, a delegated authentication method managed by a server other than the IDAAS server, such as e.g. a social server, whether government-based or not, and so on. Consequently, at least one embodiment of the invention enables more flexible authentication in terms of identity provider, and is not limited to a local authentication method managed by the IDAAS server.

At the same time, with one or more embodiments of the invention, the proof of authentication is provided with a trust score representative of the trustworthiness and/or security of the authentication method used, which allows flexibility on the part of the authentication server as it has the option of accepting the proof of authentication or not, depending on the trust score associated with it.

According to at least one embodiment of the invention, the application can be a local application located in a computer network, for example a corporate network. In this case, preferably the authentication server managing access to said application is located in said computer network.

In one or more embodiments of the invention, the application can be a web application, or a SaaS application hosted in the cloud, for example on an application server. In this case, the authentication server managing access to said application may be located on said server or on another server in communication with said application server.

According to one or more embodiments, user authentication with the IDAAS server can be performed according to any of the following methods:
a local method, managed by IDAAS: in this case, the identity provider is the IDAAS server;
a delegated method, managed by a third-party identity server other than the IDAAS server.

The third-party server can be any type of identity provider server, such as Azure AD.

The third-party server can be a federated authentication server, for example any type of identity server supporting OIDC/SAML protocols.

The third-party server can be another IDAAS server.

The third-party server may be a social authentication server, for example Google®, LinkedIn®, Facebook®, FranceConnect®, etc.

Thus, at least one embodiment of the invention makes it possible to use a variety of identity servers, or identity services, to authenticate the user and generate a proof of authentication in the event of successful authentication. Of course, these authentication methods are not equivalent in terms of security/trust, from the IDAAS point of view. These authentication methods therefore have different authentication scores.

In one or more embodiments, the authentication method can be chosen by the user while that person is on the IDAAS server.

According to one or more embodiments, the authentication method can be selected by the IDAAS server based on:
the application the user wishes to access,
the location from which the user wishes to access the application,
a registration method used to register the user with the IDAAS server, etc.

If the authentication method chosen is a local authentication method, the user is authenticated by IDAAS using one or more local authentication techniques: identifier/password, multifactor identification, etc.

If the authentication method chosen is a delegated authentication method, the user is redirected to the third-party server performing said delegated authentication. The user is authenticated by said third-party server using one or more authentication techniques: identifier/password, multifactor identification, etc. In the event of successful authentication, the third-party server generates a proof of authentication, called delegated proof of authentication, which it transmits to the IDAAS server.

The delegated proof of authentication can be used as the proof of authentication provided by the IDAAS server in the authentication message. Alternatively, the IDAAS server can generate a proof of authentication from said delegated proof of authentication received from the third-party server.

According to one or more embodiments, the authentication message may comprise:
the authentication score, and/or
at least one characteristic relating to the authentication method.

This enables the authentication server managing access to the application to be better informed about the authentication method, directly with the authentication score associated with the authentication method and/or at least one characteristic of the authentication method used.

At least one characteristic of the authentication method may be any type of characteristic relating to said authentication method or to the server having performed said authentication, such as for example:
an identifier of said authentication method,
an identification technique used to authenticate the user,
an identifier of the server performing said authentication method,
a location of the server performing said authentication method,
etc.

In one or more embodiments, for at least one authentication method, the authentication score associated with it can be modified manually, for example by an IDAAS server administrator.

This modification can be performed via an administration console, for example. In this way, it is possible to assign an authentication score manually and to modify said authentication score, for example when the third-party server changes, or when it changes which authentication method it performs.

According to one or more embodiments, the user can be pre-registered with said IDAAS according to a registration method with which is associated a score called a registration score, representative of a trust placed in said registration method, the trust score being furthermore calculated as a function of said registration score.

Thus, at least one embodiment of the invention proposes to register the user with the IDAAS server according to a plurality of registration methods, which allows greater flexibility in registering the user, and therefore greater flexibility in the authentication proposed by one or more embodiments of the invention.

The, or each, registration method is preferably associated with a registration number representative of the trust, and/or security, associated with said registration method. The trust score transmitted to the authentication server managing access to the application is also a function of said registration score, which allows flexibility on the part of the authentication server, as it has the option of accepting or rejecting the proof of authentication, depending on the trust score associated with it, the calculation of which also depends on the registration score.

According to one or more embodiments, the method according to at least one embodiment of the invention may comprise a step of registering the user on the IDAAS server, according to a registration method that is associated with a registration score representative of the trustworthiness/security of said registration method.

A user can be registered with the IDAAS server using:
a local method proposed by IDAAS: in this case, the user is registered directly with the IDAAS server; or
a delegated method offered by a third-party server: in this case, the user is registered with the third-party server, and their registration data is communicated to the IDAAS server by the third-party server.

According to at least one embodiment and by way of illustration only, user registration with the IDAAS server can be carried out according to any of the following methods:
registration by an administrator with the said IDAAS server: in this case, the administrator of a computer network, or of the application, registers the user with the IDAAS server by creating a digital identity for the user, or by communicating an existing digital identity of the user to the IDAAS server;
provisioning via API: an existing digital identity of the user is communicated to the IDAAS server via API;
self-registration by certificate: an existing digital identity of the user is communicated to the IDAAS server using a certificate;
synchronizing an identity from the information system of a computer network, using any known synchronization technique;
user self-registration with said IDAAS server: the user accesses a web page on the IDAAS server and creates a profile using one or more registration techniques proposed and managed locally by IDAAS;
user self-registration via a social authentication service: in this case, the user accesses an IDAAS server web page and selects a delegated registration method managed by a social identity service. That user is then redirected to the social server managing said identity service; on a web page of said social server, the user creates their profile using one or more registration techniques offered and managed by said social server.

Of course, these registration methods are not equivalent in terms of security/trustworthiness, from the IDAAS point of view. As a result, these registration techniques have different registration scores.

According to one or more embodiments, the registration method can be chosen by the user while that person is on the IDAAS server.

According to one or more embodiments, the registration method can be selected by IDAAS based on:
the application the user wishes to access,
the location from which the user wishes to access the application,
an authentication method that the user wishes to use to self-authenticate, etc.

If the registration method chosen is a local registration method, the user is registered with the IDAAS using one or more local registration techniques.

If the registration method chosen is a delegated registration method performed by a third-party server, the user is redirected to said third-party server performing said delegated registration. The user is registered by said third-party server using one or more registration techniques. Upon successful registration, the third-party server generates a digital identity, and optionally a user profile, which it forwards to the IDAAS server. The user's digital identity, and optionally the user's profile, is stored in the IDAAS server.

According to one or more embodiments, the method according to at least one embodiment of the invention may further comprise, after registration, a step of creating a user profile for said user, on the IDAAS server. Thus, once the user has successfully registered, a profile is created and associated with that person on the IDAAS server. This profile can be used to perform various functions.

In particular, for at least one user, the user profile may comprise at least one of the following data:
the registration score, associated with the registration method used,
the registration method used to register said user,
the identifier of an administrator who has registered said user, or who has validated said user's registration, if applicable.

According to one or more embodiments, the authentication message may comprise:
the registration score, and/or
at least one characteristic relating to the registration method.

This enables the authentication server managing access to the applications to be better informed, directly with the registration score associated with the registration method and/or at least one characteristic of the registration method used.

At least one characteristic of the registration method may be any type of characteristic relating to said registration method, or to the server having carried out said registration, or to the administrator having carried out the registration, such as for example:
an identifier of said registration method,
a registration technique used to register the user,
an identifier of the server performing said registration method,
an identifier of the administrator who registered the user,
etc.

According to one or more embodiments, for at least one registration method, the registration score associated with it can be modified manually, for example by an IDAAS server administrator.

This modification can be performed via an administration console, for example. In this way, it is possible to assign a registration score manually and to modify said registration score, for example when the third-party server changes, or when it changes which registration method it performs.

The trust score can be calculated using a predetermined relationship.

The predetermined relationship can be a mathematical relationship taking as input the authentication score and, if applicable, the registration score. For example, the trust score can be an average of the authentication and registration scores, optionally weighted differently.

The predetermined relationship can be a table, a mapping matrix taking as input the authentication score and, if applicable, the registration score. For example, the predetermined relationship can be a matrix with two inputs: one for the authentication score and another for the registration score, and indicating the trust score.

The authentication method according to at least one embodiment of the invention may furthermore comprise a step of determining a decision relating to access to the application using the proof of authentication.

During this step, the authentication message can be used by the authentication server managing access to the application to authorize or deny access to the application.

According to one or more embodiments, access to the application can be determined as a function of the trust score, and in particular by comparing said score to a first threshold value, to determine whether said score is greater than or equal to said first threshold value, and optionally as a function of:
the authentication score, and in particular by comparing said authentication score with a second threshold value, to determine whether said authentication score is greater than or equal to said second threshold value; and/or
the registration score, and in particular by comparing said registration score with a third threshold value, to determine whether said registration score is greater than or equal to said third threshold value.

When the access condition(s) set for accessing the application is/are met, the application server can authorize user access to the application. Otherwise, access is denied.

According to at least one embodiment of the t invention, a computer program is proposed comprising computer instructions, which when executed by a computer, implement the steps of the method according to one or more embodiments of the invention.

The computer program can be in machine language, in C, C++, JAVA, Python, and more generally any type of computer language.

The computer program can be a single program, or a set of several programs. For example, the computer program may comprise an IDAAS server module running on the IDAAS server, and optionally:
a first client module running on the authentication server; and/or
a second client module running on the authentication server.

According to at least one embodiment of the invention, an identity-as-a-service server, called an IDAAS server, is proposed, which is configured to authenticate a user by the method according to one or more embodiments of the invention.

According to at least one embodiment of the invention, a system for accessing an application is proposed, said system comprising:
at least one user device,
a server hosting at least one application, and
an IDAAS server;
   configured to implement all the steps of the method according to one or more embodiments of the invention.

### BRIEF DESCRIPTION OF THE DRAWINGS

Other benefits and features shall become evident upon examining the detailed description of an entirely non-limiting embodiment, and from the enclosed drawings in which:

FIG. 1 is a schematic representation of a non-limiting example of a method according to one or more embodiments of the invention,

FIG. 2 is a schematic depiction of a non-limiting example of a server according to one or more embodiments of the invention, and

FIG. 3 is a schematic depiction of a non-limiting example of a system according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior state of the art. This selection comprises at least one preferably functional feature which lacks structural details, or only has a portion of the structural details if that portion only is sufficient to confer a technical benefit or to differentiate the one or more embodiments of the invention with respect to the prior state of the art.

In the figures, the same reference has been used for the features that are common to several figures.

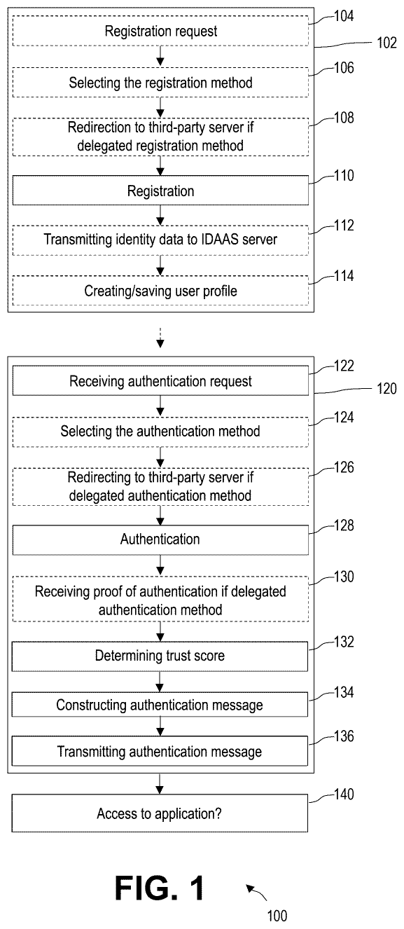

FIG. 1 is a schematic representation of a non-limiting example of a method according to one or more embodiments of the invention.

The method 100, shown in FIG. 1, can be implemented to authenticate a user in order to authorize said user to access an application, which may be
a local application hosted on an application server located in a computer network, for example a corporate computer network, or
a web application, or SaaS application, hosted on an application server in the cloud.

The method 100 comprises an optional phase 102 for registering a user with IDAAS. This phase is optional, as it might not form part of the method 100 and may be carried out prior to said method.

The registration phase 102 may comprise an optional step 104 of issuing a registration request from the user. In this step 104, the user can access the IDAAS server web page to select a registration method. This step 104 is optional, as registration can be initiated/performed differently, as will be described later.

In an optional step 106, a registration method can be selected from multiple registration methods configured/available on the IDAAS server. The registration method can be selected by:
by the user;
by the IDAAS server, e.g. depending on the application, the location from which the user is registering, etc.;
an administrator of a computer network to which the user belongs;
etc.

This step is optional, as registration can be carried out directly using a required method, for example by API, or certificate, or even synchronization, enabling the identities of users on a computer network, for example, to be transferred to the IDAAS server.

In all cases, user registration is carried out either:
by a method, called local, implemented by IDAAS;
by a method, called delegated, implemented by another server, a so-called third-party server, such as a social server or another IDAAS server, and more generally any other server implementing identity federation.

When the registration method chosen is a delegated method, in an optional step 108, the user is redirected to the third-party server to perform the registration.

During a step 110, the user is registered either on the IDAAS server using a local registration method, or on a third-party server using a delegated registration method. This registration can be carried out using one of the following methods:
registration by an administrator with the said IDAAS server: in this case, the administrator of a computer network, or of the application, registers the user with the IDAAS server by creating a digital identity for the user, or by communicating an existing digital identity of the user to the IDAAS server; this is a local registration method managed by the IDAAS server;
provisioning via API: an existing digital identity of the user is communicated to the IDAAS server via API; this is a local registration method managed by the IDAAS server;
self-registration by certificate: an existing digital identity of the user is communicated to the IDAAS server using a certificate; this is a local registration method managed by IDAAS;
synchronizing an identity from the information system of a computer network, using any known synchronization technique: this is a local registration method managed by the IDAAS server;
user self-registration with said IDAAS server: the user accesses an IDAAS server web page and creates a profile using one or more registration techniques proposed and managed locally by the IDAAS server: this is a local registration method managed by the IDAAS server;
user self-registration with a social authentication service: in this case, the user accesses an IDAAS server web page and selects a delegated registration method managed by a social identity service. That user is then redirected to the social server managing said identity service; on a web page of said social server, the user creates their profile using one or more registration techniques offered and managed by said social server; this is a delegated registration method; and
self-registration through an external identity provider: this is a delegated registration method.

A registration score is associated with each registration method and represents the trustworthiness/security of said registration method.

The registration score associated with each registration method is known to IDAAS, as it is previously entered, for example by an IDAAS administrator when configuring said registration method on the IDAAS server. The registration score associated with each registration method can be changed, for example manually, by the administrator of the IDAAS server.

When registration is carried out by a third-party server, that is, using a delegated registration method, in an optional step 112, the user's digital identity, and optionally some or all of the user's profile data, is/are transmitted to the IDAAS server.

After the registration step, in an optional step 114, a user profile is created and stored in the IDAAS server. This user profile stores at least the user's digital identity, and the registration score associated with the registration method used to register the user.

The user profile can store other data, such as a characteristic of the registration method used, an identifier of an administrator who has registered the user, the application(s) to which the user has access, for at least one application an access right granted to the user for said application, etc.

The method 100, in at least one embodiment, further comprises one or more iterations of a phase 120 for authenticating the user with an IDAAS server in order to access the application.

The authentication phase 120 can be carried out immediately after the registration phase 102. Alternatively, the authentication phase 120 can be carried out well after the registration phase 102.

The authentication phase 120 includes a step 122 wherein a user authentication request is received by the IDAAS server. According to one or more embodiments, the request can be formulated by the user directly on an Internet page of the IDAAS server. According to one or more embodiments, the authentication request may be formulated by an authentication server managing access to the application, for example following a request from the user to connect to said application. Of course, these examples are non-limiting.

The authentication phase 120 comprises an optional step 124 of selecting an authentication method.

During the optional step 124, an authentication method can be selected from multiple authentication methods configured/available on the IDAAS server. The authentication method can be selected:
by the user;
by the IDAAS, for example as a function of the application the user wishes to access, the location from which the user is requesting authentication, etc., and more generally at least one parameter relating to authentication conditions;
an administrator of the application the user wishes to access;
an administrator of a computer network to which the user belongs;
etc.

This step 124 is optional, as authentication can be performed directly according to an authentication method required, for example, by an application administrator from among the authentication methods proposed/available on the IDAAS server.

In all cases, user authentication is carried out either:
by an authentication method, called local, implemented by the IDAAS server;
by an authentication method, called delegated, implemented by another server, a so-called third-party server, such as a social server or another IDAAS server, and more generally any other server implementing identity federation.

An authentication score is associated with each authentication method and represents the trustworthiness/security of said authentication method.

The authentication score associated with each authentication method is known to IDAAS, as it is previously entered, for example by an IDAAS administrator when configuring said authentication method on the IDAAS server. The authentication score associated with each authentication method can be changed, for example manually, by the administrator of the IDAAS server.

When the authentication method chosen is a delegated method, in an optional step 126, the user is redirected to the third-party server to perform the authentication.

During a step 128, the user is authenticated either on the IDAAS server using a local authentication method, or on a third-party server using a delegated authentication method. This authentication can be carried out using any known authentication technique, such as providing a login and password, multi-factor authentication, etc.

If the authentication is successful, and the authentication is performed by the IDAAS server, that is, using a local authentication method, the IDAAS server generates a proof of authentication in step 128.

If the authentication is successful, and the authentication is performed by a third-party server, that is, using a delegated authentication method, a so-called delegated proof of authentication is generated by said third-party server. This proof of authentication is transmitted to the IDAAS server in an optional step 130. The IDAAS server can use this delegated proof of authentication as a proof of authentication to be transmitted to the authentication server managing access to the application. Alternatively, during this step 130, the IDAAS server generates its own proof of authentication from the delegated proof of authentication received from the third-party server.

In any case, the proof of authentication can be any proof of authentication known to the person skilled in the art and used for identity federation, such as an authentication token, an authentication certificate, an authentication key, etc.

In a step 132, the IDAAS server calculates a trust score based on the authentication score associated with the authentication method used, and optionally based on the registration score associated with the registration method used to register the user.

The trust score can be calculated using any predetermined relationship. For example, the trust score is given by a matrix with two inputs: one for the authentication score and another for the registration score, and an output indicating the trust score.

During a step 134, an authentication message is generated. This authentication message includes the proof of authentication and the trust score. The authentication message may further comprise any one, or any combination of at least two, of the following data:
the authentication score,
the registration score,
at least one characteristic relating to the authentication method,
at least one characteristic relating to the registration method.

The authentication message is transmitted to the authentication server managing access to the application, in a step 136

The method 100, in at least one embodiment, may then comprise an optional step 140 for making a decision regarding access to the application, based on the authentication message received. In particular, in this step the authentication message is tested to determine whether or not access is granted to the user.

During this step 140, the authentication message can be tested by the authentication server managing access to the application to authorize or deny access to the application. The test comprises a comparison of the trust score with a first threshold value, to determine whether said score is greater than or equal to said first threshold value. Optionally, the test may comprise:
comparing the authentication score with a second threshold value, to determine whether said authentication score is greater than or equal to said second threshold value; and/or
comparing the registration score with a third threshold value, to determine whether said authentication score is greater than or equal to said second threshold value.

When the condition(s) tested is/are satisfied, the application server authorizes the user to access the application. Otherwise, access is denied.

The authentication phase 120 can be repeated as many times as desired, for:
the same or different applications; and/or
the same user and/or for different users.

The application can be any type of application, such as an office application, a mail application, a banking application, etc.

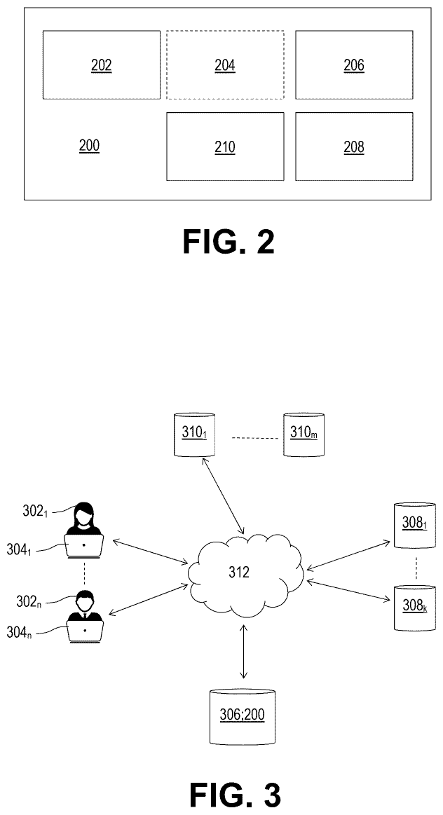

FIG. 2 is a schematic depiction of a non-limiting example of an IDAAS server according to one or more embodiments of the invention.

The IDAAS server 200 shown in FIG. 2, can be used to authenticate a user in order to authorize said user to access to an application.

The IDAAS server 200, depicted in FIG. 2, can be used to implement a method according to one or more embodiments of the invention, and in particular the method 100 in FIG. 1.

The IDAAS server 200 comprises a module 202 for administration of said IDAAS server, by one or more administrators, either locally or remotely. The administration module manages the operation of the IDAAS server. Optionally, the administration module makes it possible to assign, and optionally modify:
the authentication score associated with an authentication method and/or
where applicable, the registration score associated with a registration method.

Of course, the administration module can be used for operations other than those described above, for example, to configure an authentication method, to configure a registration method, etc.

The IDAAS server 200 comprises an optional user registration module 204. This registration module 204 can be configured to implement, within the IDAAS server, a user registration on said IDAAS server. In particular, the registration module 204 is configured to implement:
at least one local registration method, that is, a registration method performed by the IDAAS server 200; and
at least one delegated registration method, that is, involving a third-party server when registering a user, and enabling user registration based on data received from said third-party server.

In particular, the registration module 204 can be arranged/configured to implement the registration phase 102 of the method 100.

Of course, the registration module 204 can be used for operations other than those described above.

The IDAAS server 200 comprises an optional user authentication module 206. This authentication module 206 can be configured to implement user authentication within the IDAAS server. In particular, the authentication module 206 is configured to implement:
at least one local authentication method, that is, an authentication method performed by the IDAAS server 200; and
at least one delegated registration method, that is, involving a third-party server when authenticating a user, and enabling user authentication based on data received from said third-party server.

In particular, the authentication module 206 can be arranged/configured to implement steps 122-130 of the method 100, by way of at least one embodiment.

Of course, the authentication module 206 can be used for operations other than those described above.

The IDAAS server 200 comprise a module 208 for determining/calculating the trust score associated with the proof of authentication, based on:
the authentication score associated with the authentication method,
and optionally the registration score associated with the registration method.

In particular, the module 208 can be arranged/configured to implement step 132 of the method 100, according to one or more embodiments of the invention.

The IDAAS server 200 comprises a module 210 for building and transmitting an authentication message following authentication. In particular, the module 210 can be arranged/configured to implement steps 134-136 of the method 100, by way of at least one embodiment.

Of course, the IDAAS server 200 may comprise components/modules other than those described here, by way of at least one embodiment.

At least one of the modules 202-210 may be a hardware module, such as a processor, a chip, a calculator and so on.

At least one of the modules 202-210 may be a software module, such as a computer program, an application, etc.

At least one of the modules 202-210 may be a combination of at least one hardware module and at least one software module.

At least one of the modules 202-210 may be a single dedicated module.

At least two of the modules 202-210 may be integrated within a single dedicated module.

FIG. 3 is a schematic depiction of a non-limiting example of a system according to one or more embodiments of the invention.

System 300, shown in FIG. 3, can be used to authenticate users 302₁-302ₙ for access by said users to one or more applications hosted on an application server, with their user devices 304₁-304ₙ.

The system 300, shown in FIG. 3, can be used to implement any method according to one or more embodiments of the invention, and in particular the method 100 in FIG. 1.

The system 300 comprises an IDAAS server 306. The IDAAS server 306 can be an IDAAS server according to one or more embodiments of the invention, and in particular the IDAAS server 200 of FIG. 2, by way of at least one embodiment.

The system 300 further comprises one or more third-party servers 308₁-308ₖ that can be used to perform:
user registration, as part of a delegated registration method; and/or
user authentication, as part of a delegated authentication method.

The system 300 further comprises one or more application servers 310₁-310ₘ, each hosting one or more applications that users 302₁-302ₙ wish to access. At least one application server 310ᵢ can be located in the cloud. At least one application server can be located in a computer network wherein at least one of the users 302₁-302ₙ is located.

The IDAAS server 306 communicates with one or more of the system components 300 via a communication network 312, such as the Internet.

Of course, the system 300 may comprise components other than those described here, by way of at least one embodiment.

All of the examples just described are given by way of specific examples and the at least one embodiment of the invention is not limited to these examples. Numerous variants can be envisaged for the examples given above without departing from the scope of the invention as defined in the claims.

1. A method for authenticating a user to an identity-as-a-service (IDAAS) server, in order to access an application, said method comprising:
authenticating said user to said IDAAS server according to an authentication method,
in an event of successful authentication, determining a trust score as a function of an authentication score previously associated with said authentication method and representative of a trust placed in said authentication method, and
generating an authentication message comprising a proof of authentication and said trust score, intended for use by an authentication server controlling access to said application.

2. The method according to claim 1, wherein the authenticating of the user to the IDAAS server is carried out according to any one of:
a local method, managed by said IDAAS server;
delegated method, managed by a third-party identity server other than the IDAAS server.

3. The method according to claim 1, wherein the authentication message further comprises one or more of
the authentication score,
at least one characteristic relating to the authentication method.

4. The method according to claim 1, wherein, for at least one authentication method, the authentication score associated with said at least one authentication method is modified manually by an administrator.

5. The method according to claim 1, wherein the user is previously registered with said IDAAS server according to a registration method to which is associated a registration score, representative of a trust placed in said registration method, the trust score being furthermore calculated as a function of said registration score.

6. The method according to claim 5, further comprising registering the user on the IDAAS server.

7. The method according to claim 6, wherein the registering the user with the IDAAS server is carried out according to any one of:
registration by an administrator with said IDAAS server;
provisioning by an Application Programming Interface (API);
self-registration by certificate;
synchronizing an identity from an information system of a computer network;
user self-registration with said IDAAS server;
user self-registration through a social authentication service.

8. The method according to claim 6, further comprising, after said registering said user, creating a user profile for said user on the IDAAS server, said user profile comprising data that comprise one or more of
the registration score,
the registration method used to register said user,
an identifier of an administrator who has registered said user, or who has validated registration of said user, if applicable.

9. The method according to claim 5, wherein the proof of authentication further comprises one or more of
the registration score,
at least one characteristic relating to the registration method.

10. The method according to claim 5, wherein, for at least one authentication method, the authentication score associated with said at least one authentication method is modified manually by an administrator.

11. The method according to claim 10, wherein the trust score is calculated using a predetermined relationship.

12. The method according to claim 1, further comprising determining a decision relating to access to the application, using the proof of authentication.

13. A computer program comprising computer instructions, which when executed by a computer, cause the computer to implement a method for authenticating a user to an identity-as-a-service (IDAAS) server, in order to access an application, said method comprising:
authenticating said user to said IDAAS server according to an authentication method.
in an event of successful authentication, determining a trust score as a function of an authentication score previously associated with said authentication method and representative of a trust placed in said authentication method, and
generating an authentication message comprising a proof of authentication and said trust score, intended for use by an authentication server controlling access to said application.

14. The method according to claim 1, wherein An the IDAAS server is configured to authenticate the user.

15. A system that accesses an application hosted on an application server, said system comprising:
at least one user device,
a server hosting at least one application, and
an identity-as-a-service (IDAAS);
configured to implement a method for authenticating a user to said IDAAS server, in order to access said at least one application, said method comprising:
authenticating said user to said IDAAS server according to an authentication method,
in an event of successful authentication, determining a trust score as a function of an authentication score previously associated with said authentication method and representative of a trust placed in said authentication method, and
generating an authentication message comprising a proof of authentication and said trust score, intended for use by an authentication server controlling access to said application.
